(19) United States
(12) Patent Application Publication
(10) Pub. No.: US 2011/0000465 A1
(43) Pub. Date: Jan. 6, 2011

(54) METHOD AND DEVICE FOR CONTROLLING AN INJECTION SYSTEM OF AN INTERNAL COMBUSTION ENGINE

(76) Inventors: Wolfgang Stoecklein, Waiblingen (DE); Holger Rapp, Ditzingen (DE); Marco Gangi, Stuttgart (DE); Udo Schulz, Vaihingen/Enz (DE)

Correspondence Address: KENYON & KENYON LLP, ONE BROADWAY, NEW YORK, NY, 10004, US

(21) Appl. No.: 11/990,057

(22) PCT Filed: Jul. 20, 2006
(86) PCT No.: PCT/EP2006/064440

§ 371 Date: Sep. 21, 2010

(30) Foreign Application Priority Data
Aug. 2, 2005 (DE) 10 2005 036 190.0

(51) Int. Cl. F02M 51/00

(52) U.S. Cl. 123/478

(57) ABSTRACT

A method for controlling an injection system of an internal combustion engine, a fuel injection being performed using at least one piezoelectric actuator which acts directly or transmittedly on a nozzle needle of an injector, and an activation voltage determining the actuator operation being corrected as a function of a pressure wave influence of the fuel injection, provides that the pressure waves applied to the nozzle needle and caused by an injection are ascertained by measuring the actuator voltage during an injection break and the actuator voltage of a following injection is modulated in accordance with the pressure waves on the nozzle needle.

### FIELD OF THE INVENTION

The present invention relates to a method and a device for controlling an injection system of an internal combustion engine.

### BACKGROUND INFORMATION

In modern high-pressure fuel injection systems, in particular compression-ignition internal combustion engines, fuel injection is controlled by piezoelectric actuators, which typically first activate a servo valve. The switching state of this valve in turn influences the pressure in a control chamber, which either causes the opening or closing of the fuel injector. In the future, however, injectors will increasingly be used in which the actuators act directly or transmittedly on nozzle needles of injectors for fuel injection while dispensing with the servo valve.

A very widespread injection system of the type relevant here, which is described in German Published Patent Application No. 100 02 270, is the so-called “common rail (CR) injection system,” in which fuel is temporarily stored in a high-pressure accumulator (rail) before it is supplied to the individual injectors.

For this purpose, the fuel is frequently injected by a number of partial injections, which allow improved mixture formation and thus lower exhaust gas emissions of the internal combustion engine in particular, lower noise development during combustion, and increased power output of the internal combustion engine. It is desirable in particular to be able to vary the time interval between two partial injections without restriction.

The precision of the particular injected quantity has great significance for the fuel injections and in particular for the multiple partial injections cited. However, it has simultaneously been recognized that each injection using an injector of CR injection systems of this type causes a brief drop in the fuel pressure in a supply line, which is situated in the injection system, from the rail to the affected injector, as well as in such an injector itself from a high-pressure connection attached to the rail to a nozzle needle of the injector. In addition, closing the nozzle needle results in a pressure increase. The combination of pressure drop and pressure increase results in a fuel pressure wave, which preferably occurs between the rail and the injector. This pressure wave results in particular in undesired oscillations of the particular injected fuel quantity, this pressure wave effect even being reinforced with increasing needle velocity of the nozzle needle of the injector, so that it will be increasingly important to consider it, in particular also in future injection systems, in which high-speed piezoelectric control elements are used as injection actuators for nozzle needle control in the particular injector.

The cited pressure wave influence decreases as the time interval between the particular neighboring injections increases. As a result, the influence on the injected quantity of a particular subsequent injection also decreases as the time interval increases and approximates the undisturbed quantity which would be obtained using a chronologically isolated injection for sufficiently large time intervals.

Because the described pressure wave effects are strictly systematic in nature, and are essentially a function of the time interval of the participating injections, the injected fuel quantity, the hydraulic fuel pressure, and the fuel temperature in the hydraulically relevant line system, they may be corrected by a suitable activation function in the engine control unit. An approach for minimizing the cited pressure wave influence, which is described, for example, in German Published Patent Application No. 101 23 035, therefore includes measuring this influence on the injected quantities of the particular injectors and taking the results of this measurement into consideration when presetting the activation data of the injection system, for example. A corresponding correction of the cited activation data is based on an array of fuel quantity waves, previously ascertained empirically or experimentally, as a function of the time interval between each two or even multiple partial injections. The cited pressure wave compensation saves the quantity influence, which is measured on a reference system, on a following injection in operating maps and compensates for the influence on the run-time of the internal combustion engine by a corresponding change in the power supply time of the particular following injection, i.e., the activation time of the following injection. The typical procedure in the related art described above accordingly consists basically of ascertaining the cited quantity waves. The increased or reduced quantities thus ascertained are stored in the cited operating maps and compensated for at the run-time of a CR control program by a corresponding deduction in a quantity pathway of the engine controller.

However, this algorithm functions with the required precision only in the event of completely linear quantity conversion or activation time operating maps. In contrast, if nonlinearities occur in the cited operating maps (for example, a slope change or the like), the algorithm used causes systematic errors in the pressure wave compensation.

In order to also remedy these disadvantages, German Patent Application No. 10 2004 014 367 describes the cited pressure wave compensation being performed on the basis of actuation time waves instead of the cited quantity waves. In other words, the activation time is changed while knowing a particular activation time wave such that a desired injected quantity is achieved.

The method is used in particular in injectors in which the closing force acting on the nozzle needle is transmitted via a servo valve. In such injectors, the nozzle needle may only be influenced by the switching state of the servo valve, i.e., it may solely be opened or closed in quasi-digital form. In contrast, it is not possible to vary the force acting on the nozzle needle. In injectors having direct needle control (CRI-PDN), the piezoelectric actuator acts on the nozzle needle directly or transmittedly by a mechanical or hydraulic coupler. In these actuators, the actuator and the coupler are enclosed by a larger fuel volume under rail pressure. As a result of this noteworthy volume in this area, the pressure oscillations which arise as a result of the injection between this actuator chamber and the rail are of a lower amplitude. However, each injection triggers a pressure oscillation at the nozzle seat. This oscillation has a lower amplitude than in typical injectors actuated using a servo valve, but the oscillation frequency is comparatively high. This has the result that following an injection, e.g., a pilot injection, the pressure difference between the pressure at the needle seat, which determines the nozzle needle opening force, and the pressure in the coupler, for example, in a hydraulic coupler, which determines the nozzle needle closing force, is also subject to a high-frequency oscillation. The pressure at the needle seat for the pressure reduction in the coupler required for nozzle opening as well as the activation voltage and the voltage reduction required for the nozzle opening following a pilot injection of such an actuator are schematically shown in FIG. 2. Up to this point, as is also shown in FIG. 2, it has been typical to always charge the actuator to one voltage—which is possibly dependent on the rail pressure—in the activation breaks. The voltage of the piezoelectric actuator is reduced in relation thereto during the activation time. The nozzle needle closing force is thus reduced and as soon as this falls below the nozzle needle opening force, the nozzle needle begins to open. The previously described pressure oscillation has a significant effect on the injected quantity in particular in the event of injections which follow one another closely. Quantity Q of the second injection which is injected at constant activation times by two sequential injections as a function of time interval tdiff of the injections thus oscillates significantly. As a result of the high frequency of the pressure oscillations, high gradients of injected quantity dQ/dtdiff also occur, causing the precision of the pressure wave compensation in the control unit to be significantly impaired.

In addition, the mechanical closing force, via which the nozzle needle is pressed into its seat, is subject to oscillations following an injection, which result in increased wear of the nozzle seat during operation of the injector.

The influence of the pressure waves in the supply lines from the rail to the particular injector may be reduced purely in principle by installing a throttle in the supply line from the rail to the injector. The pressure spikes, which are possibly harmful to the high-pressure circuit and which continue up to the injector, are thus simultaneously avoided. A pressure wave correction may be performed on the basis of the rail pressure arising in the supply line. However, pressure sensors would be required in the supply line for each cylinder for this purpose. Thus, the same number of pressure sensors as cylinders are required. Such a large number of pressure sensors results in high costs and significant installation effort.

### SUMMARY

Example embodiments of the present invention provide a method and a device of the type cited at the outset allowing improved pressure wave compensation at the lowest possible installation effort and at low cost. In particular, pressure sensors for detecting the rail pressure are to be dispensed with.

Example embodiments of the present invention are based on using injectors having direct needle control themselves as sensor elements for detecting the pressure wave applied to the needle of the injector. For this purpose, the sensory effect of the piezoelectric actuator is used. Because injectors of this type having direct needle control (CRI-PDN) are charged during the injection breaks and/or in the time intervals between the activation times, the length change as a result of the changing force action of a changing fuel pressure in the injector, i.e., the injection pressure, may be determined by measuring the change in the actuator voltage.

The measurement of the actuator voltage may be started after the end of injection and ended with an ensuing beginning of injection. In addition to the actuator voltage, the rail pressure and the fuel temperature are measured, and the time interval of two injections and the activation time are detected. The pressure waves themselves are determined by measuring the amplitude, in particular the peak-peak values of the pressure wave, and/or the actuator voltage zero.

The activation voltage determined in this manner by measurement may be stored as a function of the rail pressure ascertained in a dynamic interrupt, the fuel temperature, the time interval of two injections, and the activation time in an operating map space or a matrix in a control unit of the internal combustion engine, the activation voltage of a following injection being modulated in accordance with the pressure waves thus ascertained, and the value for the activation time of the next injection being correspondingly corrected.

An aspect of this method is a very precise pressure wave correction which takes into consideration the exemplary scattering, aging effects, drift effects of the high-pressure circuit up to the injection-relevant fuel pressure, and fuel influences, without additional pressure sensors being required in every high-pressure line to the injector.

Example embodiments of the present invention also relate to a device for controlling an injection system of the type discussed above, which, according to example embodiments, has a circuit element for ascertaining the actuator voltage applied to the nozzle needle during an injection break and for modulating the activation voltage of a following injection in accordance with the detected actuator voltage.

Example embodiments of the present invention are explained in greater detail in the following and with reference to the drawings, in which further characteristics, features, and aspects are presented.

### BRIEF DESCRIPTION OF THE DRAWINGS

FIG. 1 is a schematic illustration of a conventional injector having direct needle control, which is suitable for use in connection with example embodiments of the present invention.

FIG. 2 illustrates the pressure on the needle seat, the pressure reduction in the coupler required for nozzle opening, the activation voltage, and the voltage reduction required for nozzle opening following an injection according to a conventional method for activating a piezoelectric actuator of an injector having direct nozzle needle control.

FIG. 3 is a schematic block diagram of a device for activating a piezoelectric actuator using corrected activation voltages.

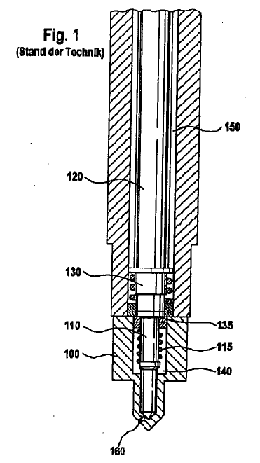

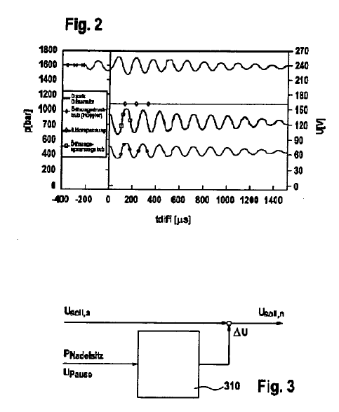

### DETAILED DESCRIPTION

The components of an injector having direct nozzle needle control required for understanding the following, as are presented in German Patent Application No. 10 2004 014 367, which is expressly incorporated herein in its entirety by reference thereto, include a nozzle body 100, in which a nozzle needle 110 is movably guided in the axial direction of nozzle body 100 against the restoring force of a spring 115.

Nozzle needle 110 is operated by a piezoelectric actuator 120 directly via a hydraulic coupler, i.e., without a control valve being interposed, as is the case in conventional injectors. The hydraulic coupler has an actuator-side transmission piston 130, which acts on nozzle needle 110 via a gap 135.

Nozzle needle 110 is enclosed by a nozzle-side high-pressure chamber 140. Actuator 120 and hydraulic coupler 130 are enclosed by an actuator-side high-pressure chamber 150, which is filled with fuel under rail pressure. As a result of the noteworthy volume in this area, the pressure oscillations which occur as a result of the injections between actuator-side high-pressure chamber 150 and the high-pressure accumulator (rail) are of a lower amplitude. Each injection triggers a pressure oscillation at a seat 160 of nozzle needle 110. Not only do these oscillations corrupt the injected fuel quantity, but they also result in wear of nozzle needle 110 and nozzle seat 160 because nozzle needle 110 is acted upon by a pulsing force in the injection breaks, which acts on nozzle seat 160, causing nozzle needle 110 to “vibrate” on nozzle seat 160.

These pressure oscillations are measured via a high-frequency continuous measurement during the injection breaks of actuator 120 by measuring activation voltage UBreak applied to actuator 120. The measurement begins at the end of injection and ends at the beginning of an ensuing injection. The measured variables of rail pressure and fuel temperature are also measured once simultaneously with the measurement of the activation voltage during injection break UBreak. Injection times are typically determined in common rail systems of this type in so-called static and dynamic interrupts. In a static interrupt of the particular cylinder, the activation beginning of the next injection(s) is calculated. In a dynamic interrupt, while taking the computing and hardware run-times of the controller of the control unit into consideration, the activation time of the particular injection(s) is calculated as closely as possible before the activation beginning. The variables used as the basis for calculating the activation time are the rail pressure, the desired setpoint quantity, and the starting value of the pressure wave correction function. The pressure oscillation is described using a minimum number of data points. It is ascertained by searching the peak-peak values and/or by searching the zero crossings.

In the dynamic interrupt, the rail pressure, the fuel temperature, the injection interval to the preceding injection, and the activation time of the preceding injection are measured/determined and stored as input variables of an operating map space or a matrix, for example, whose dimension corresponds to the number of input variables. The value from the operating map space or the matrix represents the multiplicative correction for the fuel pressure in the rail measured in the dynamic interrupt, which is measured by a rail pressure sensor, for example, or to the measured fuel pressure in the actuator, which is ascertained by measuring activation voltage during injection break UBreak. The ascertained value of the fuel pressure to be expected in a following injection is determined by a type of extrapolation of the stored values of preceding injections. For this purpose, on the basis of the measured variables of rail pressure, fuel temperature, injection interval to the preceding injection, and activation time of the preceding injection, the currently relevant parameters are ascertained from the learned pressure oscillations, such as the wavelength, the phase position, and the peak-peak value of the pressure wave. The fuel pressure in the rail measured at the instant of the dynamic interrupt or the measured fuel pressure in the actuator describes the position of the pressure wave. Because the next injection beginning is fixed, the fuel pressure at the main injection instant may be determined via the interval between the dynamic interrupt and the injection beginning and the precise knowledge of the pressure wave, i.e., its wavelength, its phase position, and its peak-peak value, and in this manner the activation time required for achieving the desired injection quantity may be calculated. This is performed using circuit element 310 illustrated in FIG. 3, which uses voltage UBreak, which corresponds to the pressure at needle seat Pneedle_seat, as an input variable. A deviation from a preset value of activation voltage Uset, a is calculated from this variable and additively applied to this value, so that a new activation voltage Uset, n results, which is finally applied to piezoelectric actuator 120.

The activation voltage is accordingly modulated on the basis of previously ascertained pressure oscillations which are stored in the control unit and are adapted if needed by computer in real time to parameters changed in relation to the original calculation.

Transferring example embodiments of the present invention to charge-controlled systems is possible. All voltage, setpoint, and actual values are replaced in this case by charge, setpoint, and actual values.

1-10. (canceled)

11. A method for controlling an injection system of an internal combustion engine, comprising:
performing a fuel injection using at least one piezoelectric actuator, which acts at least one of (a) directly and (b) transmittedly on a nozzle needle of an injector;
correcting an activation voltage, which determines an actuator operation, as a function of a pressure wave influence of the fuel injection;
ascertaining the pressure waves applied to the nozzle needle and caused by an injection by measuring an actuator voltage during an injection break; and
modulating the actuator voltage of a following injection in accordance with the pressure waves on the nozzle needle.

12. The method according to claim 11, wherein the measurement of the actuator voltage is started after an end of an injection and is ended upon an ensuing beginning of an injection.

13. The method according to claim 11, wherein at least one of (a) a rail pressure and (b) a fuel temperature are measured in addition to the actuator voltage, and at least one of (a) a time interval of two injections and (b) an activation time are taken into consideration.

14. The method according to claim 11, wherein the pressure waves are determined by measuring at least one of (a) amplitudes and (b) the actuator voltage zero.

15. The method according to claim 11, wherein the pressure waves ascertained by measuring the activation voltage are stored as a function of at least one of (a) a rail pressure ascertained in a dynamic interrupt, (b) a fuel temperature, (c) a time interval of two injections, and (d) a activation time in an operating map space or a matrix in a control unit of the internal combustion engine and the activation voltage of a following injection is modulated in accordance with the pressure waves ascertained.

16. The method according to claim 15, wherein the activation voltage is computer-adapted in real time to parameters which have changed in relation to a preceding calculation.

17. A device for controlling an injection system of an internal combustion engine, comprising:
at least one piezoelectric actuator configured to perform a fuel injection, the piezoelectric actuator adapted to act at least one of (a) directly and (b) transmittedly on a nozzle needle of an injector;
a device configured to correct an activation which determines a fuel quantity to be injected a function of a pressure wave influence of the fuel injection; and
a circuit device configured to ascertain an actuator voltage curve occurring during an injection break and to modulate the activation voltage of a following injection in accordance with the detected actuator voltage.

18. The device according to claim 17, wherein the circuit element is part of a control unit of the internal combustion engine.

19. The device according to claim 17, wherein a corrected activation voltage is adaptable by the circuit element in real time to parameters which have changed in relation to preceding calculations.

20. The device according to claim 17, wherein the at least one piezoelectric actuator acts on the nozzle needle in at least one of (a) a mechanically and (b) a hydraulically transmitted manner.
